(19) United States
(12) Patent Application Publication
(10) Pub. No.: US 2009/0262085 A1
(43) Pub. Date: Oct. 22, 2009

(54) SMART GLASS TOUCH DISPLAY INPUT DEVICE

(76) Inventors: Tomas Karl-Axel Wassingbo, Malmo (SE); Anders Eibye, Kopenhamn S (DK)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/106,418

(22) Filed: Apr. 21, 2008

(51) Int. Cl. G06F 3/041

(52) U.S. Cl. 345/173

(57) ABSTRACT

An improved touch display input device for incorporation into a portable electronic device is described. In exemplary embodiments, the touch display includes a smart glass layer that selectively blocks and transmits light from a light source to a transparent touch input surface. As a result of the selectivity of the smart glass, a particular set of characters and/or symbols may become visible to the user through the transparent touch surface. The user may select a visible character or symbol by touching the character or symbol on the touch display. The selective blocking and transmission of light by the smart glass may be altered to display different sets of input characters and/or symbols depending upon the operational state of the portable electronic device.

### TECHNICAL FIELD OF THE INVENTION

The technology of the present disclosure relates generally to portable electronic devices, and more particularly to a smart glass touch display input device for use in a portable electronic device.

### DESCRIPTION OF THE RELATED ART

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera (still and/or video), an Internet browser for accessing news and information, an audiovisual media player, a messaging device (text, audio, and/or visual messages), a gaming device, a personal organizer, and have other functions as well.

With this increased functionality, user input devices on portable electronic devices have become more sophisticated. For example, input devices are no longer confined to conventional tactile keypads as are commonly found on mobile telephones and other electronic devices. One alternative input device is a touch display or touch screen input device, by which a user inputs a character or functional command by merely touching or lightly pressing a display. Commonly, such touch displays are liquid crystal displays that display input functions, such as alphanumeric characters, media control icons, and/or other symbols or characters as may be found on a typical keypad. Liquid crystal touch screen displays have certain disadvantages. For example, they have a relatively high power consumption rate. In addition, being typically made using a glass substrate, they are relatively fragile and rigid, which limits how they may be incorporated into a portable electronic device. Mobile telephones and other portable electronic devices often have uneven surfaces, particularly on the back or side surfaces, on which it is difficult to place a rigid liquid crystal touch screen of a user-friendly size.

Currently unrelated to portable electronic devices, switchable glass technology has been developed. Switchable glass, sometimes referred to colloquially as “smart glass”, alters its light transmissive characteristics upon application of an input voltage. For example, applying an input voltage to a smart glass panel may cause the glass to switch from dark or opaque to transparent or translucent. Smart glass has been used to provide “privacy windows” to adjust the privacy of homes and other buildings, or portions of them, such as changing or bathing rooms, showers, and the like. Similar concepts have been used to increase the energy efficiency of windows. For example, in summer, smart glass may be used to reduce the amount of sunlight transmitted into a home or office building at mid day, thereby reducing the workload on the air conditioning system required to keep the building cool.

Several smart glass technologies are being developed. As are known in the art, suspended particle devices (SPDs) are typically dark or opaque in a non-activated state. They become transparent when a voltage is applied, and states between full opaqueness and full transparency may be achieved depending on the SPD properties and the input voltage. To maintain a non-opaque state, the input voltage must be maintained.

Another smart glass technology is liquid crystal devices. Similar to SPDs, conventional liquid crystal smart glass is dark or opaque in the non-activated state and becomes transparent when a voltage is applied. The voltage must be maintained to maintain the transparent state. In contrast to SPDs, however, liquid crystal devices typically may achieve only two states, opaque and transparent, but not intermediate states.

Another smart glass technology is electrochromic devices. Electrochromic devices may be switched from relatively opaque translucence to transparence upon application of an input voltage. In contrast to the other technologies, however, a continuous voltage typically need not be maintained to maintain a non-opaque state, but rather the glass will retain the non-opaque state, once achieved, even after the voltage is deactivated. Application of an additional input voltage may return the glass to its original state. In this manner, the transparence of an electrochromic device may be switched “on” and “off” without having to maintain a continuous voltage to maintain a given state. In addition, similar to SPD devices, various degrees of transparence may be obtained depending upon the glass characteristics and input voltage.

As stated above, smart glass conventionally is used in windows and similar enclosures. The technology, being essentially focused on that field, apparently is not being fully exploited.

### SUMMARY

To improve the consumer experience with electronic devices, there is a need in the art for an improved input device, and in particular for an improved touch display input device for incorporation into a portable electronic device.

In exemplary embodiments, an improved touch display input device includes a smart glass layer that selectively blocks and transmits light from a light source to a transparent touch input surface. As a result of the selectivity of the smart glass, a particular set of characters and/or symbols may become visible to the user through the transparent touch surface. The user may select a visible character or symbol by touching the character or symbol on the touch display. The selective blocking and transmission of light by the smart glass may be altered to display different sets of input characters and/or symbols depending upon the operational state or mode of the portable electronic device. For example, in a messaging mode, the selectivity of the smart glass may result in an alphanumeric character set being visible through the transparent touch surface. In a media player mode, the selectivity of the smart glass may result in media player function keys (stop, play, pause, etc.) being visible through the transparent touch surface, and so on.

Therefore, according to one aspect of the invention, a touch display input device for an electronic device comprises a light source, a switchable glass layer having elements that are selectively activated to form regions that transmit light and regions that block light from the light source, the regions being configured to correspond to a plurality of potential inputs for the electronic device, and a touch surface for receiving the light transmitted through the glass layer, wherein the touch surface is sensitive to receiving an input action from a user corresponding to an input for the electronic device.

According to one embodiment of the touch display, the regions of the smart glass layer that transmit light form the plurality of potential inputs for the electronic device.

According to one embodiment of the touch display, the regions of the smart glass layer that block light form the plurality of potential inputs for the electronic device.

According to one embodiment of the touch display, the touch display further comprises a template layer having cutouts for selectively permitting pass through of light from the light source to the switchable glass layer.

According to one embodiment of the touch display, the cutouts correspond to a conglomeration of potential inputs for a plurality of operational states of the electronic device.

According to one embodiment of the touch display, a first group of cutouts correspond to a first operational state of the electronic device and a second group of cutouts correspond to a second operational state of the electronic device, and in the first operational state, the switchable glass layer is selectively activated to have a light transmitting region corresponding to the first group of cutouts, and in the second operational state, the switchable glass layer is selectively activated to have a light transmitting region corresponding to the second group of cutouts.

According to one embodiment of the touch display, the switchable glass layer is one of a suspended particle device (SPD), liquid crystal, or electrochromic switchable glass layer.

According to one embodiment of the touch display, the switchable glass layer is made of a flexible material.

According to one embodiment of the touch display, the touch display conforms to a non-planar surface of the electronic device.

According to another aspect of the invention, an electronic device comprises a touch display input device comprising a light source, a switchable glass layer having elements that may be selectively activated to form regions that transmit light and regions that block light from the light source, and a touch surface for receiving the light transmitted through the glass layer. A controller is configured to selectively activate regions of the glass layer so that the glass layer selectively transmits and blocks light from the light source to the touch surface in a configuration corresponding to a plurality of potential inputs for the electronic device, wherein the touch surface is sensitive to receiving an input action from a user corresponding to an input for the electronic device.

According to one embodiment of the electronic device, the controller is configured selectively activate regions of the glass layer corresponding to a plurality of potential inputs associated with a first operational state of the electronic device.

According to one embodiment of the electronic device, the controller is configured to change the operational state of the electronic device to a second operational state, and the controller is further configured to alter to selective activation of regions of the glass layer to correspond to potential inputs associated with the second operational state.

According to one embodiment of the electronic device, the touch display further comprises a template layer having a plurality of cutouts for selectively permitting pass through of light from the light source to the glass layer.

According to one embodiment of the electronic device, the cutouts correspond to a conglomeration of potential inputs for a plurality of operational states of the electronic device.

According to one embodiment of the electronic device, a first group of cutouts correspond to a first operational state of the electronic device and a second group of cutouts correspond to a second operational state of the electronic device, and in the first operational state, the switchable glass layer is selectively activated to have a light transmitting region corresponding to the first group of cutouts, and in the second operational state, the switchable glass layer is selectively activated to have a light transmitting region corresponding to the second group of cutouts.

According to one embodiment of the electronic device, the switchable glass layer is one of a suspended particle device (SPD), liquid crystal, or electrochromic switchable glass layer.

According to one embodiment of the electronic device, the switchable glass layer is made of a flexible material.

According to one embodiment of the electronic device, the electronic device has a non-planar surface, and the touch display conforms to the non-planar surface.

According to one embodiment of the electronic device, the electronic device is a mobile telephone.

Another aspect of the invention is a method of using a touch display input device to provide an input to an electronic device. The method comprises the steps of generating light from a light source, selectively activating regions of a switchable glass layer to permit and block transmission of portions of the light from the light source, wherein the selective activation is configured to correspond to a plurality of potential inputs for the electronic device, transmitting the unblocked portion of light from the light source through the selectively activated regions of the switchable glass layer, transmitting the portion of light that was transmitted through the glass layer through a touch surface such that the light is visible to a user and is configured to display a plurality of potential inputs for the electronic device, and receiving an input action from the user.

According to one embodiment of the method, the method further comprises selectively passing the light from the light source through a template layer having a plurality of cutouts.

According to one embodiment of the method, the cutouts correspond to a conglomeration of potential inputs for a plurality of operational states of the electronic device.

According to one embodiment of the method, the method further comprises entering a first operational state of the electronic device, and configuring the touch display to provide a plurality of potential inputs associated with the first operational state.

According to one embodiment of the method, the method further comprises changing the operational state of the electronic device to a second operational state, and reconfiguring the touch display to provide a plurality of potential inputs associated with the second operational state.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic side view of a touch display input device in accordance with an embodiment of the present invention.

FIG. 2 is a schematic exploded view of the touch display input device of FIG. 1 in accordance with an embodiment of the present invention.

FIGS. 3A-3C are schematic views of a smart glass layer for use in accordance with an embodiment of the present invention.

FIGS. 4A and 4B are schematic representations of portions of the template and smart glass layers in an exploded view and sandwich configuration respectively, in accordance with an embodiment of the present invention.

FIGS. 5A-5C depict an example demonstrating a manner by which activated and non-activated regions of a smart glass layer may be combined to display input groupings in accordance with an embodiment of the present invention.

FIGS. 6A-6C depict variations on how non-activated and activated regions of a smart glass layer may be combined to display a variety of input groupings, in accordance with embodiments of the present invention.

FIG. 7 is a flow chart depicting an exemplary method of providing an input to an electronic device in accordance with an embodiment of the present invention.

FIG. 8 is a schematic block diagram of operative portions on an exemplary electronic device for use in accordance with embodiments of the present invention.

FIG. 9 is a flow chart depicting an exemplary method of operating a touch display input device in accordance with an embodiment of the present invention.

FIG. 10 is a schematic front view of a mobile telephone as an exemplary electronic device for use in accordance with an embodiment of the present invention.

FIG. 11 is a schematic rear view of the mobile telephone of FIG. 10.

FIG. 12 is a schematic side view of the mobile telephone of FIG. 10.

FIG. 13 is a schematic block diagram of operative portions of the mobile telephone of FIG. 10.

### DETAILED DESCRIPTION OF EMBODIMENTS

The present invention provides for an improved touch display input device for incorporation into an electronic device, and into a portable electronic device in particular. In exemplary embodiments, the touch display includes the following four layers in a “sandwich” or stacked configuration: (1) a light source, (2) a template layer, (3) a switchable smart glass layer, and (4) a transparent touch surface. As used herein, the terms “switchable” glass and “smart” glass are synonymous and interchangeable.

The light source generates light for the touch display and may be a light guide or comparable structure. The template layer permits selective pass through of light from the light source. The template layer may act much like a stencil to selectively transmit light in a configuration of a conglomeration of characters and symbols that may correspond to potential inputs for the electronic device. For example, the template layer may permit the pass through of light corresponding to inputs including alphanumeric characters, symbols and icons, word commands, and the like. The smart glass layer selectively blocks and transmits light to the transparent touch surface. As a result of the selectivity of the smart glass, a particular subset of the template layer characters, words, icons, and/or symbols may become visible to a user through the transparent touch surface. The user may select an input by touching a particular visible character, word, icon, or symbol on the touch display. The selective blocking and transmission of light by the smart glass may be altered to display different sets of inputs depending upon the operational state or mode of the portable electronic device. For example, in a messaging mode, the selectivity of the smart glass may result in an alphanumeric character set being visible through the transparent touch surface. In a media player mode, the selectivity of the smart glass may result in media player function keys (stop, play, pause, etc.) being visible through the transparent touch surface, and so on.

In a preferred embodiment, the smart glass is a flexible smart glass. For example, an electrochromic coating may be applied to a flexible substrate, such as a transparent plastic film or the like. Other flexible smart glass technologies may be employed. A touch display with such a flexible smart glass layer may be provided on uneven or non-planar surfaces, as are commonly found on the back and side surfaces of portable electronic devices. In addition, if the flexible smart glass is based upon electrochromic technology, the smart glass may not require application of a continuous voltage to maintain a non-opaque state. Such smart glass, therefore, may provide for more efficient power consumption than other smart glass technology, thereby resulting in reduced battery depletion with use. It will be appreciated that various other types of smart glass may be employed.

Embodiments of the present invention will now be described with reference to the drawings, wherein like reference numerals are used to refer to like elements throughout. It will be understood that the figures are not necessarily to scale.

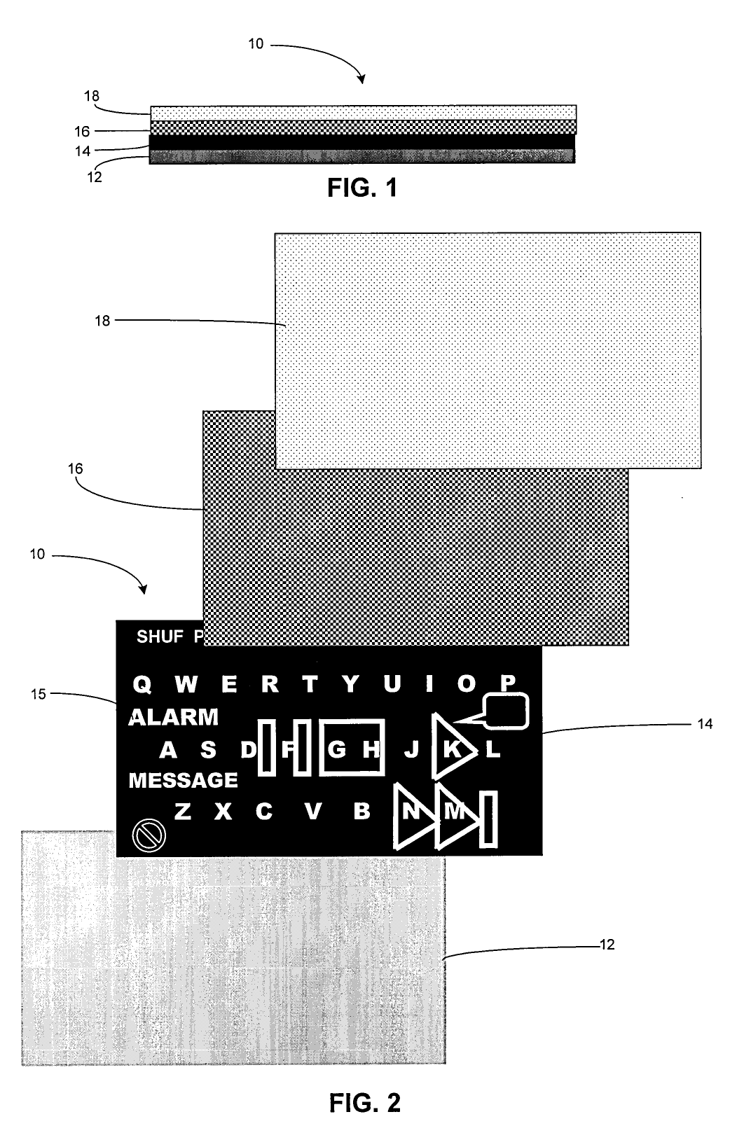

FIG. 1 depicts a side view of an exemplary embodiment of a touch display input device 10. The touch display may include the following four layers in a “sandwich” or stacked configuration: a light source 12, a template layer 14, a smart glass layer 16, and a transparent touch layer 18.

FIG. 2 depicts an exploded view of the touch display input device 10 of FIG. 1. The light source 12 is generally conventional and may be a light guide or similar structure for providing a backlight source for the touch display.

Template layer 14 is made of a substantially opaque material, such as an opaque plastic film or similar. Template layer 14 contains a plurality of cutouts 15 that selectively permit passage of light from the light source through the template layer. The cutouts 15 may be configured to form a conglomeration of characters, symbols, icons, and word commands that may correspond to potential inputs for an electronic device having the touch display 10. For example, in FIG. 2 one can see cutouts corresponding to a “QWERTY” keyboard, media control commands, word commands, and other symbols and icons that may correspond to potential inputs for use in a variety of operational modes and functions of an electronic device. It will be appreciated that the configuration of the cutouts depicted in FIG. 2 is exemplary, and other cutout configurations alternative to or additional to the configuration of FIG. 2 may be employed.

Touch display 10 further includes a smart glass layer 16, the structure and function of which are described in more detail below. A transparent touch layer 18 is provided on top of the smart glass layer. The transparent touch layer may be a generally conventional touch screen surface and provides a user interface for entering information and commands. As is known in the art, the transparent touch layer 18 may be provided with appropriate sensors (not shown), such as tactile sensors, capacitive sensors, and the like, which may sense physical input actions by a user with a finger or input instrument, such as a stylus.

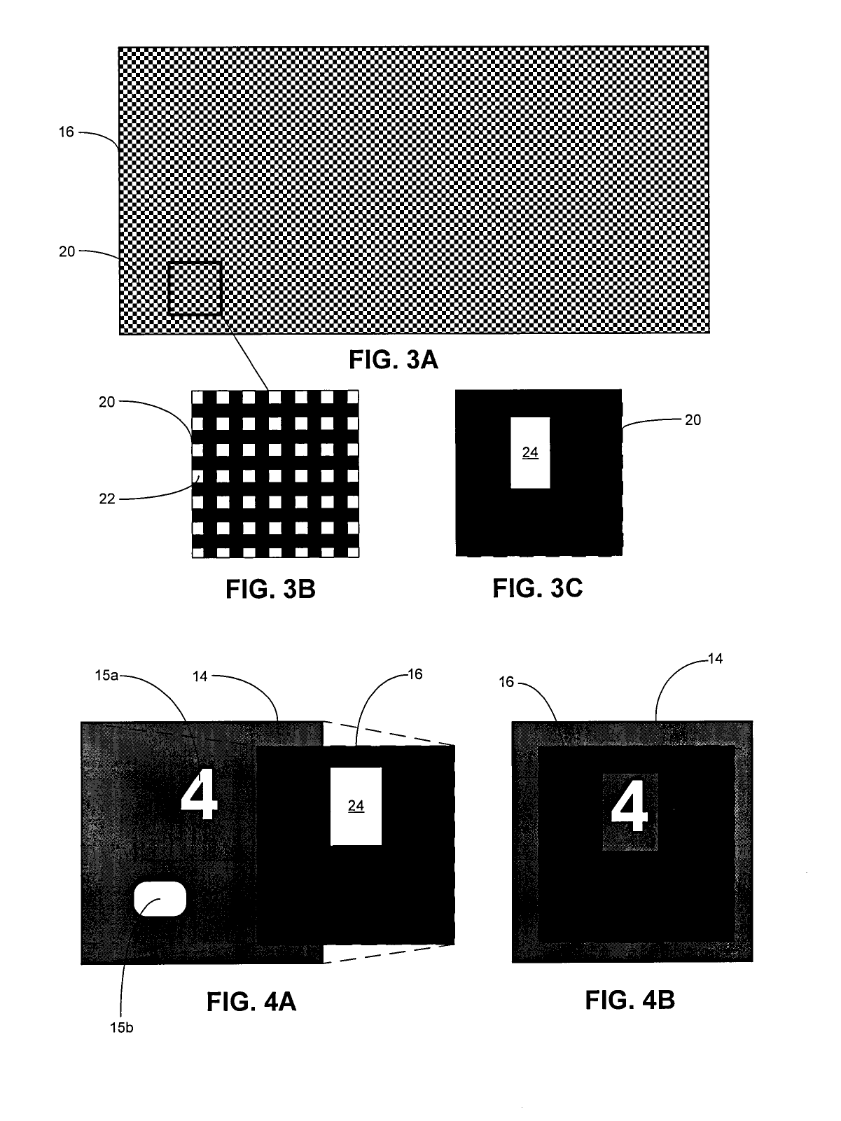

FIGS. 3A-3C depict an exemplary smart glass layer 16. Smart glass layer 16 includes a matrix 20 of selectively activated elements 22, each of which may receive an activation input voltage from a voltage source (not shown). As stated above, generally, when activated by an input voltage, smart glass tends to become transparent relative to its non-activated state. FIG. 3B depicts an exemplary portion of the matrix 20 of elements 22. As shown, with the matrix 20 of elements 22, each element is separately addressable for activation. The technology for separately addressing elements in a matrix is known to those skilled in the art (e.g., various pixel technologies), and therefore is not described here in great detail. FIG. 3B depicts the matrix 20 in an exemplary state in which every other element 22 is activated, resulting in the checkered configuration of alternating transparent and opaque regions. In actual operation, activated elements typically may be combined to form regions of relative transparence, an example of which is depicted in FIG. 3C. As shown in FIG. 3C, for example, a plurality of elements 22 may be activated in combination to form a rectangular activated region 24 of relative transparence surrounded by a non-activated, relatively opaque region.

FIGS. 4A and 4B depict an example demonstrating how the template layer 14 and the smart glass layer 16 may cooperate to permit the display of a single character input command. FIG. 4A depicts portions of the template and smart glass layers in an exploded view, as represented by the dashed lines. This portion of the template layer includes cutouts 15 including cutout 15a of a number “4” input, as may be used, for example, in a telephone calling mode of a portable electronic device. This portion of template layer 14 also includes a second cutout 15b for a command symbol that, for purposes of this example, would not be used in a calling mode. The portion of smart glass layer 16 in this example includes an activated region 24 of multiple elements in a box configuration. The activated region is transparent relative to the surrounding non-activated region.

FIG. 4B depicts these elements in a sandwich configuration as they may be located within an electronic device. Light from the light source (not shown in these figures) may pass through the template layer through both cutouts “4” and the symbol. For a calling mode, however, the elements of the smart glass layer are selectively activated so as to permit passage only of the light coming through the cutout “4”. Light coming through the symbol is blocked by non-activated portions of the smart glass. The “4” input, therefore, would appear to the user in the transparent touch layer (not shown in these figures). Should the user switch to an operational mode in which a “4” input 15a is not desirable and the symbol input 15b is, then the smart glass activation may be reconfigured commensurately so that the symbol input appears in the transparent touch layer, and the “4” input is blocked. These principles may be applied to selectively display touch inputs for other characters and symbols, and groups thereof, as well.

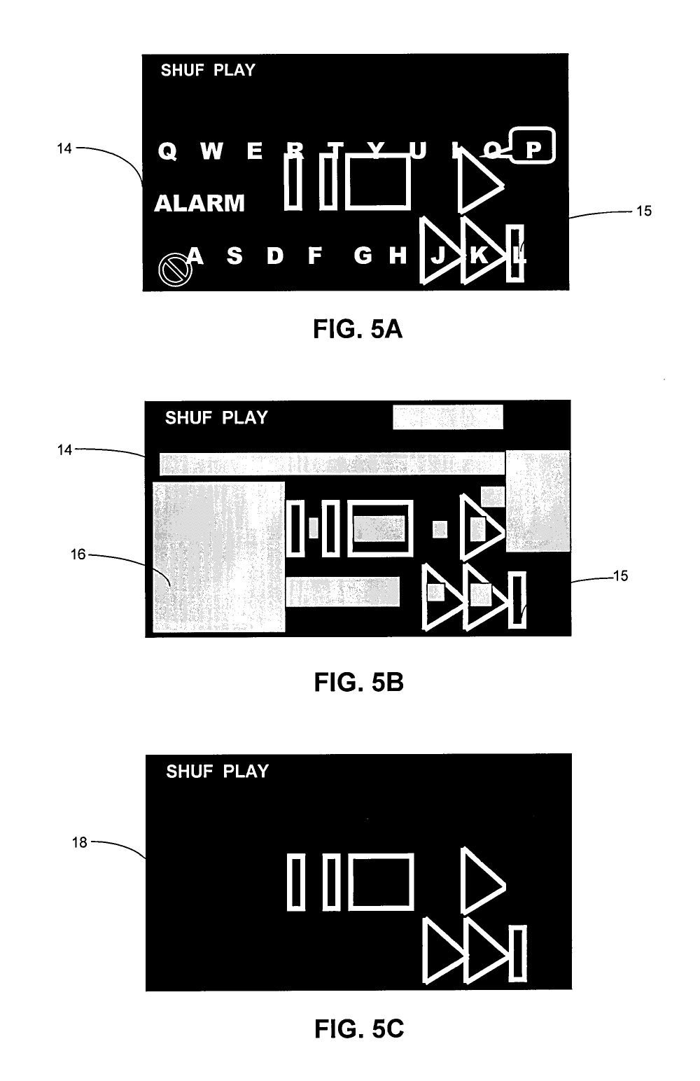

FIGS. 5A-5C depict an exemplary manner by which activated and non-activated regions of the smart glass may be combined to display input groupings that correspond to an operational mode of an electronic device. In this example, it is assumed that a user has activated a media player function via any conventional method. FIG. 5A depicts an entire exemplary template layer 14 containing a conglomeration of cutouts 15. This figure is similar to the template layer of FIG. 2, and the cutouts correspond to potential inputs that may span a variety of operational modes and functions. FIG. 5B depicts how non-activated regions of the smart glass layer 16 may be combined to block or mask command inputs that may not be desirable or used for media player functionality. The grey boxes represent the regions of the template layer that would be blocked by the smart glass configuration. The grey boxes are illustrative to show the blocked regions, but would not appear to the user in the transparent touch layer. Rather, as depicted in FIG. 5C, the user would see, against a blank background, the non-blocked inputs in the transparent touch layer 18, which in this example correspond to icons and word commands for controlling the media player function. The user may execute a given command by touching or lightly pressing the appropriate input icon as is conventional in a touch screen display.

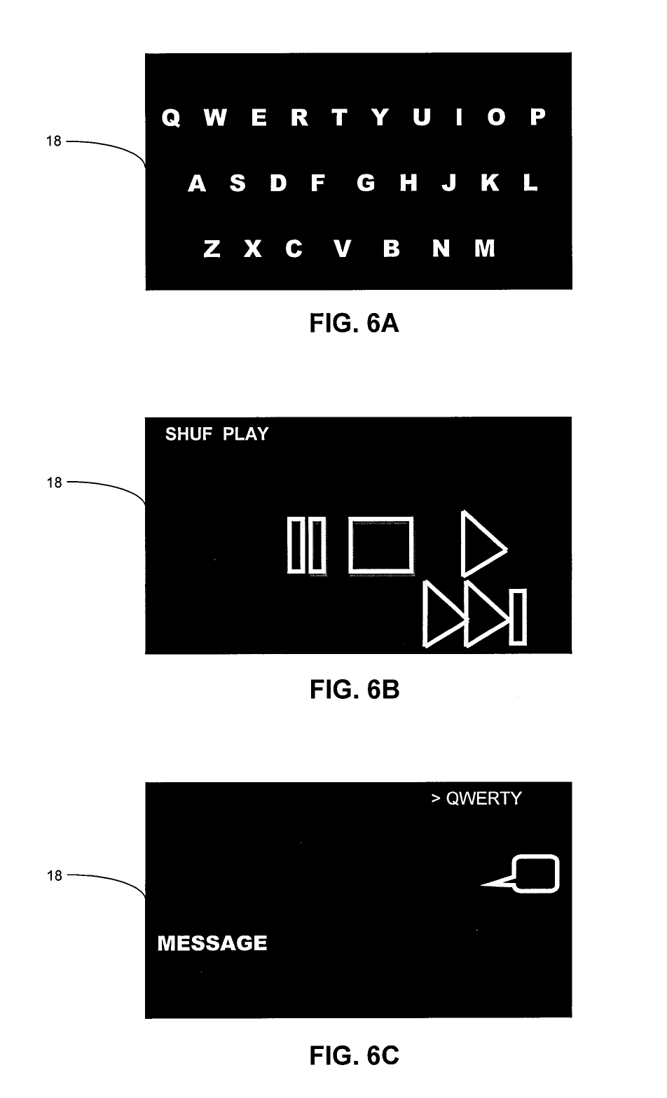

FIGS. 6A-6C depict variations on how non-activated and activated regions of the smart glass may be combined to display a variety of input groupings, as would be visible through the transparent touch layer 18. For example, FIG. 6A depicts a “QWERTY” style keyboard, FIG. 6B depicts a media player control pad as seen in previous figures, and FIG. 6C depicts a dormant or “standby” mode from which other functional modes may be selected. It will be appreciated that these are examples, and other functional input groupings may be generated by the selective activation and non-activation of regions of the smart glass and/or configuration of the template layer. The visual characteristics of the display also are exemplary. For example, the figures depict light characters and icons on a dark background. The blocking and transmissive regions of the template layer and/or smart glass may be reversed or otherwise altered to produce dark characters and icons on a light background. Different regions of the touch display may be provided with different shading contrasts, and color may be introduced by the use of filters or other known means. Accordingly, numerous variations of the content and visual characteristics of the touch display may be employed without departing from the scope of the invention.

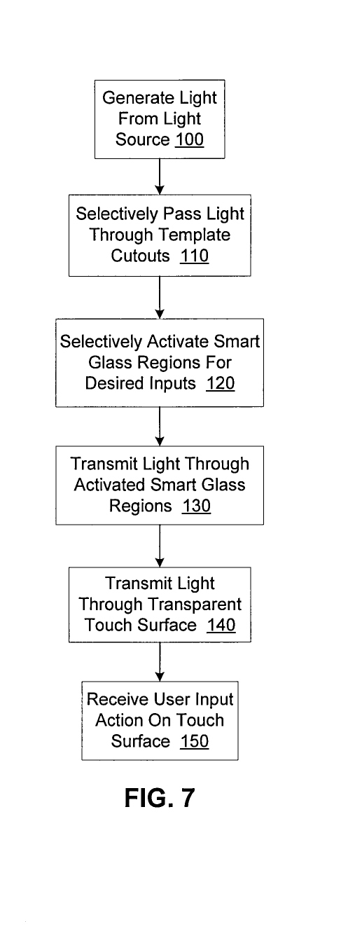

In accordance with the previous description, FIG. 7 depicts an exemplary method of providing an input to an electronic device using the touch display input device described herein in accordance with an embodiment of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 100 in which light may be generated from a light source, such as a light guide or other conventional backlight device. At step 110, the light from the light source may be selectively passed through a template having a plurality of cutouts. The cutouts may correspond to a conglomeration of potential inputs for an electronic device spanning a variety of operational modes and functions. At step 120, regions of a smart glass layer may be selectively activated to permit transmission of a portion of the light that had passed through the template. The precise configuration of activation may be based on the desired input options for a particular operational mode or function of the electronic device. At step 130, the regions of the smart glass that are selectively activated may transmit a portion of the light that had previously passed through the template. At step 140, the light corresponding to the desired inputs may be transmitted through a transparent touch surface such that the desired inputs are visible to a user. At step 150, an input action may be received from the user. For example, the user input action may be a capacitive or tactile input using a finger or an input instrument, such as a stylus.

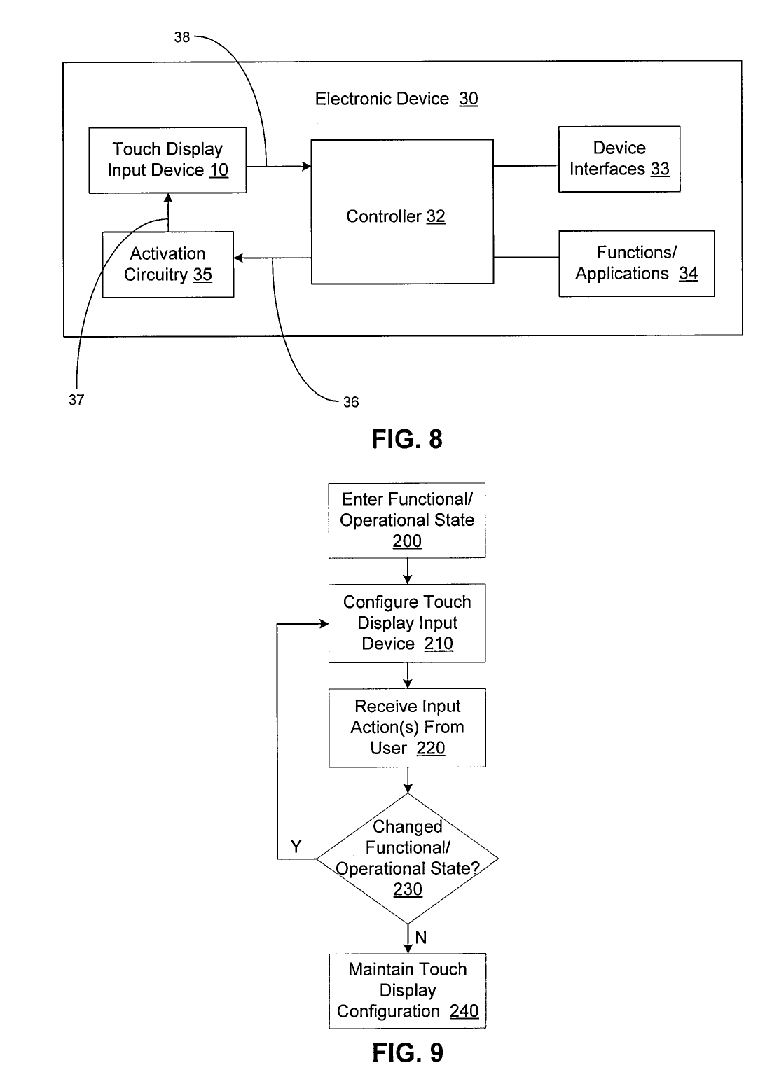

FIG. 8 is a schematic block diagram depicting operable portions of an exemplary electronic device 30, in which the touch display input device 10, described above, may be incorporated. Electronic device 30 may be one of a variety of electronic device types, examples of which include a mobile telephone, a media player, a gaming device, or a desktop or laptop computer. For purposes of the description herein, the interchangeable terms “electronic equipment” and “electronic device” also may include portable radio communication equipment. The term “portable radio communication equipment,” which sometimes herein is referred to as a “mobile radio terminal,” includes all equipment such as mobile telephones, pagers, communicators, electronic organizers, personal digital assistants (PDAs), smartphones, and any communication apparatus or the like.

Electronic device 30 may include a controller 32 for carrying out the overall functions of the device. The electronic device also may include a variety of device interfaces 33. The device interfaces may include wireless interfaces that permit communication between the electronic device 30 and other devices over a wireless network. The device interfaces 33 also may include ports and connectors for communication with other electronic devices over a wired path or network. The device interfaces 33 also may include user interfaces, such as a conventional keypad and the like, that permit a user to enter input commands and information.

The electronic device also may contain numerous functions and applications 34 for performing a variety of device functions. The functions and applications may be embodied as executable program code that is executed by the controller 32. Exemplary applications may include such items as calling and voice communication functions, camera functions (still and/or video), Internet browsing, audiovisual and multimedia functions, messaging (text, audio, and/or visual messages), gaming, and others. In addition, although the functions and applications 34 are depicted in FIG. 8 as being resident in the electronic device 30, it will be appreciated that they may also be resident in external electronic devices, such as network servers or storage devices. External functions and applications may be accessed via the wireless and/or wired interfaces that are included as part of the devices interfaces 33.

The touch display input device 10 may be located and operate within the electronic device 30 as follows. By action governed by the controller 32, the electronic device 30 may enter a particular state or operational mode. The electronic device may do so either manually or automatically. For example, the electronic device may automatically enter a calling mode upon receipt of a telephone call, or automatically enter a messaging mode upon receipt of a text or multimedia message. A user also may manually select these and other operational states or modes in any conventional manner, such as by selection from a menu or pressing a dedicated input button. Once a particular state has been entered, the controller may send command signals to activation circuitry 35 via a control path 36. The activation circuitry 35 may then send appropriate activation input voltage signals along an activation path 37 to the touch display 10. The activation input voltage signals received by the touch display 10 may result in the selective activation and non-activation of the elements of the smart glass layer, as described above, to achieve a touch display commensurate with the operational state of the electronic device. For example, should a user manually select a media player function of the electronic device, the result may be a touch display configured in the manner shown in FIG. 5C. In one embodiment, a smart glass that does not require a constant voltage, such as an electrochromic smart glass, is used to provide for better power efficiency, since a continuous voltage is not required to maintain the smart glass in any given configuration of activated and non-activated regions.

The touch display may then be used to input information and commands by touching or depressing an appropriate character, symbol, command, icon etc. depicted in the touch display. As described above, the inputs depicted in the touch display may vary depending upon the operational state of the electronic device. Input signals may then be transmitted from the touch display to the controller along an input path 38. The controller 32 may interpret the “touched” area of the touch display. The interpretation may be derived from signals from the touch display that identify the function to be performed based on the activated regions of the smart glass. Once interpreted, the controller may generate control inputs to the functions/applications 34 to invoke an operation of the electronic device that corresponds to the sensed touch.

In one embodiment, the touch display may be configured to have a default or standby configuration from which a device function or operational state may be selected by the user. In this manner, the touch display itself may provide another mechanism for selecting the operational state of the device. The configuration of the touch display may then alter to provide appropriate inputs for the selected operational state.

In accordance with the previous description, FIG. 9 depicts an exemplary method of operating a touch display input device for an electronic device in accordance with an embodiment of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 200 in which the electronic device may enter a given functional or operational state. The functional or operational state, for example, may be an initial standby or default state, an operational mode (calling, messaging, etc.), a state of executing an application (Internet browsing, media player, gaming, etc.), or others. At step 210, the touch display input device may be configured to display desired inputs for the functional or operational state of the electronic device. The touch display may be configured according to the method set forth in FIG. 7 above. At step 220, the touch display may receive one or more input actions from a user. As before, an exemplary input action may be a capacitive or tactile input from a user, using a finger or an input instrument such as a stylus. At step 230, a determination may be made as to whether the functional or operational state of the electronic device has changed. If not, then at step 240, the current configuration of the touch display is maintained. If the functional or operational state of the electronic device has changed, then the method may return to step 210, and the touch display may be reconfigured to accommodate the new functional or operational state.

In one embodiment, the electronic device 30 is a mobile telephone 40. Although the following description is made in the context of a conventional mobile telephone, as stated above, it will be appreciated that the invention is not intended to be limited to the context of a mobile telephone and may relate to any type of appropriate electronic device.

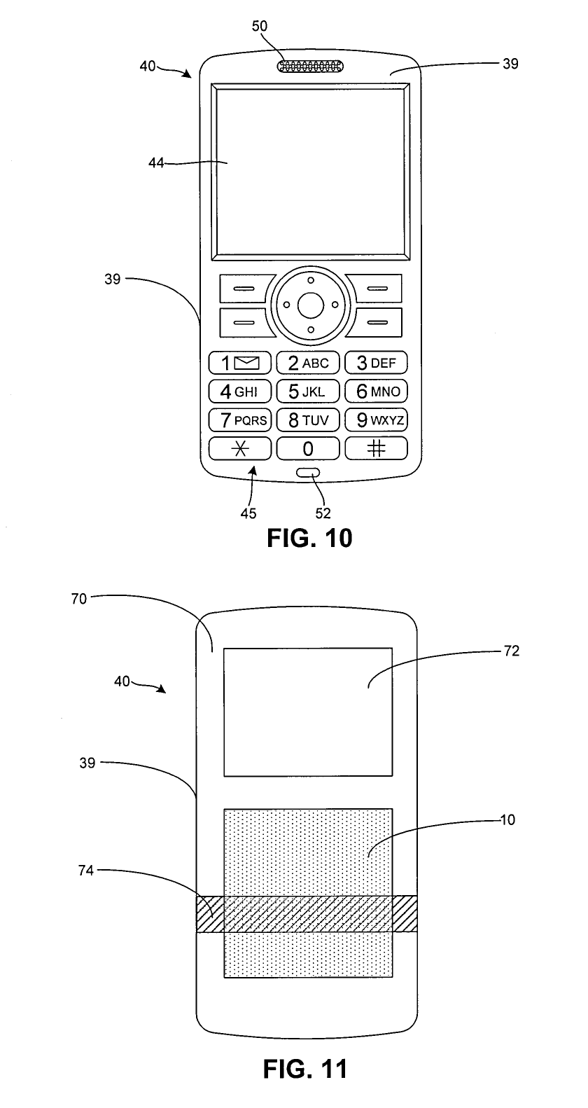

FIG. 10 depicts an exemplary mobile telephone 40 having a housing 39 that forms a “block” or “brick” configuration. The mobile telephone may have other configurations, such as, for example, a clamshell, pivot, swivel, and/or sliding cover configuration as are known in the art. Mobile telephone 40 has a display 44 that displays information to a user regarding the various features and operating state of the mobile telephone 40, and displays visual content received by the mobile telephone 40 and/or retrieved from an internal memory.

A keypad 45 provides for a variety of user input operations. For example, keypad 45 typically includes alphanumeric keys for allowing entry of alphanumeric information such as telephone numbers, phone lists, contact information, notes, etc. In addition, keypad 45 typically includes special function keys such as a “send” key for initiating or answering a call, various navigational operations, and others. Some or all of the keys may be used in conjunction with the display as soft keys. Keys or key-like functionality also may be embodied as a touch display in accordance with embodiments of the present invention, either independently or associated with the display 44.

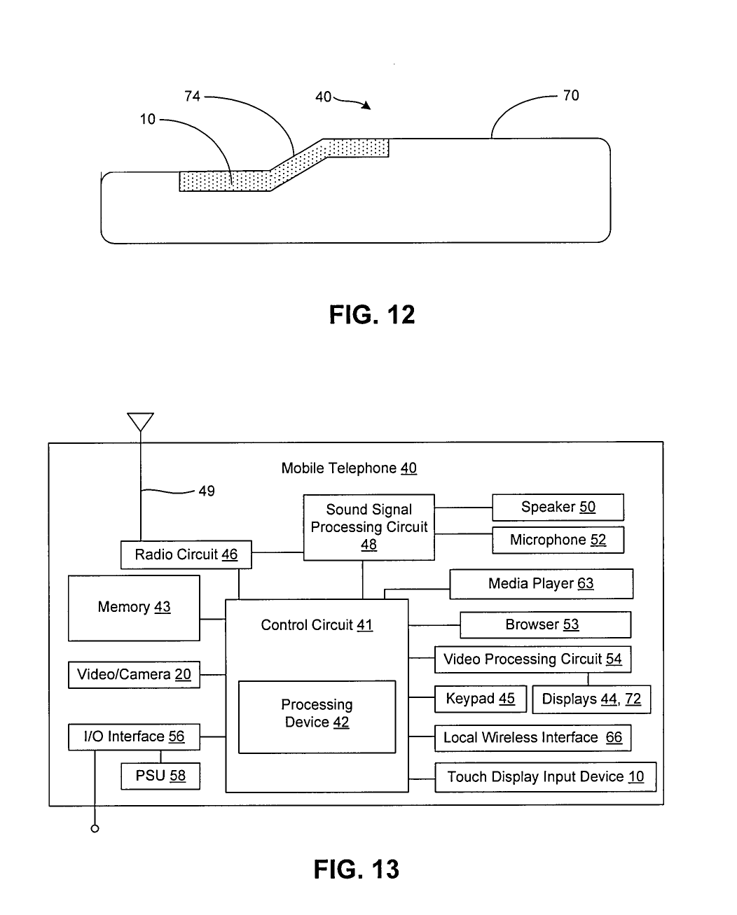

FIGS. 11 and 12 depict schematic rear and side views of the exemplary mobile telephone 40 of FIG. 10. FIGS. 11 and 12 further depict an exemplary placement of the touch display input device 10 within the mobile telephone 40. The housing 39 of mobile telephone 40 may include a rear surface 70 containing a secondary display 72 that is similar to the front display 44. In this embodiment, the touch display 10 also is incorporated into the rear surface 70. In embodiments in which the mobile telephone may have a clamshell or slide cover configuration (or similar), the secondary display 72 and touch display 10 are visible and accessible even when the mobile telephone is in the closed position (in which the front display 44 and keypad 45 would be unavailable). This configuration, therefore, may permit access to various phone features when the telephone is closed.

As is common, a mobile telephone may have one or more non-planar or uneven surfaces. In the example of FIGS. 11 and 12, an uneven surface is represented by the slanted surface 74. The uneven surface may be any non-planar surface, such as a concave surface, convex surface, or faulted surface, or others. Touch display 10 may conform to the non-planar surface. As stated above, in one embodiment the smart glass layer 16 is fashioned in accordance with a flexible smart glass technology. For example, the smart glass may be an electrochromic coating applied to a flexible plastic film or similar substrate, although any flexible smart glass technology may be used. The flexible smart glass layer 16 may conform to uneven surfaces in the housing of the electronic device. The uneven surface need not be the rear surface, but may include sides, edges, and other uneven surfaces of an electronic device. The touch display 10 also may be positioned on a front surface of the mobile telephone, and in one embodiment, may replace the keypad 45.

In one embodiment, the touch display input device does not have the template is layer. Instead, regions of the smart glass layer may be selectively activated to conform directly to the desired inputs for each given functional or operational state of the electronic device. In this embodiment, the individual elements of the matrix in the smart glass are small and/or numerous enough to accurately depict the input command characters and symbols without the aid of the template layer. In this manner, the smart glass may act similarly to a high resolution pixilated device. Because of the higher resolution, this embodiment may be used to display images other than input commands, which tend to be graphically simple. For example, wall paper images, backgrounds, photographs, and the like may be reproduced in the smart glass layer. For embodiments lacking the template layer, the makeup of the smart glass and accompanying activation circuitry may become more complex to manufacture and may be more difficult to incorporate into electronic devices. This may be true particularly of portable electronic devices due to their small size and the desire for low power consumption. The template layer, therefore, though desirable in many circumstances, may not always be a necessary component.

FIG. 13 represents a functional block diagram of operable portions of the mobile telephone 40. Referring to FIGS. 10 and 13, additional features of the mobile telephone 40 will now be described. For the sake of brevity, generally conventional features of the mobile telephone 40 will not be described in great detail herein.

The mobile telephone may include a controller in the form of a control circuit 41 and/or a processing device 42 for carrying out overall telephone function. The controller may operate in conjunction with the touch display 10 in the manner described above with respect to the controller 32 of electronic device 30 (see FIG. 8). The controller 32, therefore, may be embodied as the control circuit 41 and/or the processing device 42. In addition, the functions/applications 34 may be executed by the processing device 42 in an embodiment in which the functions/applications are embodied as executable logic instructions.

The mobile telephone 40 includes call circuitry that enables the mobile telephone 40 to establish a call and/or exchange signals with a called/calling device, typically another mobile telephone or landline telephone, or another electronic device. The mobile telephone 40 also may be configured to transmit, receive, and/or process data such as text messages, often referred to as “SMS” (which stands for short message service) messages. The mobile telephone 40 also may configured to transmit, receive, and/or process electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in a memory 43, executing applications to allow user interaction with data, displaying video and/or image content associated with the data, outputting audio sounds associated with the data and so forth.

The mobile telephone 40 may include an antenna 49 coupled to a radio circuit 46. The radio circuit 46 includes a radio frequency transmitter and receiver for transmitting and receiving signals via the antenna 49 as is conventional. The mobile telephone 40 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 40 as is conventional.

The displays 44 and 72 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 43, derived from an incoming video data stream received by the radio circuit 46 or obtained by any other suitable method. A media player 63 within the mobile telephone may be used to play audiovisual files stored in memory or streamed over a network.

The mobile telephone 40 also may include a local wireless interface 66, such as an infrared transceiver and/or an RF adaptor (e.g., a Bluetooth adapter), for establishing communication with an accessory, another mobile radio terminal, a computer or another device. The mobile telephone 40 also may include an I/O interface 56 that permits connection to a variety of I/O conventional I/O devices. One such device is a power charger that can be used to charge an internal power supply unit (PSU) 58.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A touch display input device for an electronic device comprising:
a light source;
a switchable glass layer having elements that are selectively activated to form regions that transmit light and regions that block light from the light source, the regions being configured to correspond to a plurality of potential inputs for the electronic device; and
a touch surface for receiving the light transmitted through the glass layer, wherein the touch surface is sensitive to receiving an input action from a user corresponding to an input for the electronic device.

2. The touch display of claim 1, wherein the regions of the smart glass layer that transmit light form the plurality of potential inputs for the electronic device.

3. The touch display of claim 1 further comprising a template layer having cutouts for selectively permitting pass through of light from the light source to the switchable glass layer.

4. The touch display of claim 3, wherein the cutouts correspond to a conglomeration of potential inputs for a plurality of operational states of the electronic device.

5. The touch display of claim 1, wherein the switchable glass layer is one of a suspended particle device (SPD), liquid crystal, or electrochromic switchable glass layer.

6. The touch display of claim 1, wherein the switchable glass layer is made of a flexible material.

7. The touch display of claim 6, wherein the touch display conforms to a non-planar surface of the electronic device.

8. An electronic device comprising:
a touch display input device comprising a light source, a switchable glass layer having elements that may be selectively activated to form regions that transmit light and regions that block light from the light source, and a touch surface for receiving the light transmitted through the glass layer; and
a controller configured to selectively activate regions of the glass layer so that the glass layer selectively transmits and blocks light from the light source to the touch surface in a configuration corresponding to a plurality of potential inputs for the electronic device;
wherein the touch surface is sensitive to receiving an input action from a user corresponding to an input for the electronic device.

9. The electronic device of claim 8, wherein the controller is configured selectively activate regions of the glass layer corresponding to a plurality of potential inputs associated with a first operational state of the electronic device.

10. The electronic device according to claim 9, wherein the controller is configured to change the operational state of the electronic device to a second operational state, and the controller is further configured to alter to selective activation of regions of the glass layer to correspond to potential inputs associated with the second operational state.

11. The electronic device of claim 8, wherein the touch display further comprises a template layer having a plurality of cutouts for selectively permitting pass through of light from the light source to the glass layer.

12. The electronic device of claim 11, wherein the cutouts correspond to a conglomeration of potential inputs for a plurality of operational states of the electronic device.

13. The electronic device of claim 8, wherein the switchable glass layer is one of a suspended particle device (SPD), liquid crystal, or electrochromic switchable glass layer.

14. The electronic device of claim 8, wherein the switchable glass layer is made of a flexible material.

15. The electronic device of claim 14, wherein the electronic device has a non-planar surface, and the touch display conforms to the non-planar surface.

16. The electronic device of claim 8, wherein the electronic device is a mobile telephone.

17. A method of using a touch display input device to provide an input to an electronic device comprising the steps of:
generating light from a light source;
selectively activating regions of a switchable glass layer to permit and block transmission of portions of the light from the light source, wherein the selective activation is configured to correspond to a plurality of potential inputs for the electronic device;
transmitting the unblocked portion of light from the light source through the selectively activated regions of the switchable glass layer;
transmitting the portion of light that was transmitted through the glass layer through a touch surface such that the light is visible to a user and is configured to display a plurality of potential inputs for the electronic device; and
receiving an input action from the user.

18. The method of claim 17 further comprising selectively passing the light from the light source through a template layer having a plurality of cutouts.

19. The method of claim 17 further comprising:
entering a first operational state of the electronic device; and
configuring the touch display according to the method of claim 17 to provide a plurality of potential inputs associated with the first operational state.

20. The method of claim 19 further comprising:
changing the operational state of the electronic device to a second operational state; and
reconfiguring the touch display according to the method of claim 17 to provide a plurality of potential inputs associated with the second operational state.
